(19) United States
(12) Patent Application Publication
(10) Pub. No.: US 2009/0222860 A1
(43) Pub. Date: Sep. 3, 2009

(54) VIDEO RECORDING DEVICE AND RESERVED VIDEO RECORDING METHOD THEREOF

(75) Inventor: LIEN-FU HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/189,118

(22) Filed: Aug. 8, 2008

(30) Foreign Application Priority Data
Feb. 29, 2008 (CN) 200810300424.4

(51) Int. Cl. G06F 13/00

(52) U.S. Cl. 725/58

(57) ABSTRACT

A video recording device includes a mail transceiving module, a mail analyzing module, and a scheduling module. The mail transceiving module retrieves an E-mail including a title, an identification message, and a video request. The mail analyzing module analyzes the title and the identification message to determine whether the title and the identification message comply with predefined requirements. The scheduling module automatically schedules the video request when both the title and the identification message comply with the predefined requirements. A reserved video recording method is also provided.

### BACKGROUND OF THE INVENTION

1. Field of the Invention

The present invention relates to video processing devices, and particularly to a video recording device and a reserved and scheduled video recording method thereof.

2. Description of Related Art

A conventional video recording device such as a set-top box (STB) with a video recording function typically needs to be pre-set with a video recording request prior to recording video data. However, if a user of the video recording device is not at home and wants to record a TV program, he/she would typically be unable to do so without the help of a friend or family member.

Therefore, a heretofore unaddressed need exists in the video recording device to overcome the aforementioned deficiencies and inadequacies.

### SUMMARY OF THE INVENTION

An exemplary embodiment of the present invention provides a video recording device. The video recording device includes a mail transceiving module, a mail analyzing module, and a scheduling module. The mail transceiving module retrieves an E-mail including a title, an identification message, and a video request. The mail analyzing module analyzes the title and the identification message to determine whether the title and the identification message comply with predefined requirements. The scheduling module automatically schedules the video request when both the title and the identification message comply with the predefined requirements.

Another exemplary embodiment of the present invention provides a reserved and scheduled video recording method applied in the video recording device. The reserved video recording method includes the steps of: retrieving an E-mail including a title, an identification message, and a video request; analyzing the title to determine whether the title complies with predefined requirements; analyzing the identification message to determine whether the identification message complies with the predefined requirements if the title complies with the predefined requirements; and automatically scheduling the video request if the identification message complies with the predefined requirements.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic diagram of an application environment and function modules of a video recording device according to an exemplary embodiment of the present invention; and

FIG. 2 is a flowchart of a reserved and scheduled video recording method according to another exemplary embodiment of the present invention.

### DETAILED DESCRIPTION OF THE INVENTION

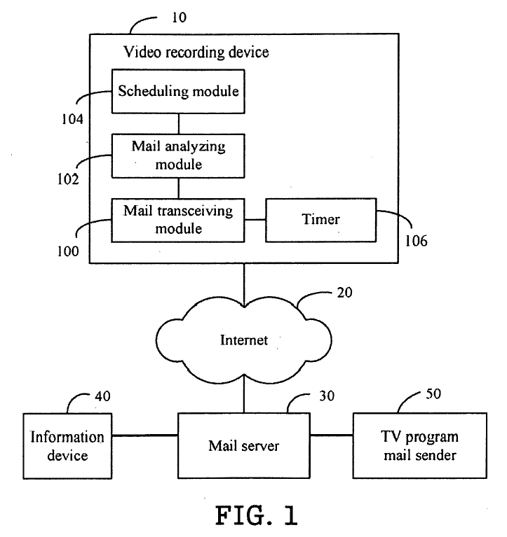

FIG. 1 is a schematic diagram of an application environment and functional modules of a video recording device 10 according to an exemplary embodiment of the present invention. In the exemplary embodiment, the video recording device 10 connects to a mail server 30 over the Internet 20, and further connects to an information device 40 and a television (TV) program mail server 50 via the mail server 30. In this embodiment, the video recording device 10 is an electronic device, such as a set-top box (STB) or a personal computer (PC) with a TV card, which can be connected to the Internet 20 for recording video data under control. The information device 40 is a device that can be connected to the Internet 20, such as a mobile phone, a personal digital assistant (PDA), a notebook computer, or a personal computer.

In one exemplary embodiment of the present invention, a user of the video recording device 10 may use the information device 40 to send an E-mail with a video request to the video recording device 10 via the mail server 30 over the Internet 20. After receiving the E-mail, the video recording device 10 schedules video data to be recorded according to the video request in the E-mail.

In another exemplary embodiment of the present invention, the user of the video recording device 10 may subscribe to TV programs from a TV system operator via E-mail, telephone, or another means. The TV program mail sender 50 could send an E-mail with a TV program list to the video recording device 10. The video recording device 10 receives the E-mail with the TV program list via the mail server 30 over the Internet 20, and then schedules the TV programs to be recorded according to the TV program list.

Thus, the user can record video data conveniently by sending an E-mail with the video request to the video recording device 10 without having to be near the video recording device 10. The video recording device 10 then schedules the video data to be recorded according to the video request in the E-mail.

In this embodiment, the video recording device 10 includes a mail transceiving module 100, a mail analyzing module 102, a scheduling module 104, and a timer 106.

The mail transceiving module 100 is provided for retrieving the E-mail. In the exemplary embodiment, the timer 106 reminds the mail transceiving module 100 to retrieve the E-mail periodically. The mail transceiving module 100 connects to the mail server 30 when notified to do so by the timer 106, and retrieves the E-mail from the mail server 30.

In another exemplary embodiment, the video recording device 10 may not include the timer 106, and the mail transceiving module 100 may connect to the mail server 30 to retrieve E-mail when a new mail notice is sent by the mail server 30.

In this exemplary embodiment, the E-mail includes a title, an identification message, and the video request. The title primarily identifies whether the E-mail includes the video request, and can be distinguished by identifying words such as “reserved video recording” or “TV program list.”

The identification message includes a username, a password, and an encrypted key. The username and password included in the E-mail must be correct in order for the video request to be accepted. The encrypted key ensures that the transferred information is secure.

The video request includes a video recording channel, a program class, a recording type, a start time, an end time, program description information, recording extending information, and so on. The video recording channel indicates the channel of the video to be recorded from the video request. The program class indicates a class of the video data, which includes sports, educations, news, entertainments, and so on. The recording type indicates a recording type of the video data, including high definition (HD), standard definition (SD) and so on. The start time indicates a time when the video data starts to be played. The end time indicates a time when the video data ends playing. The program description information includes brief description of the video data. The recording extending information includes extending information of the video data, such as an extending game of baseball or football.

When the sender of the E-mail is the information device 40, the title of the E-mail may be distinguished by identifying words such as “reserved video recording,” the identification message may only include the username and the password, and the video request may only include the video recording channel, the start time, and the end time, etc.

When the sender of the E-mail is the TV program mail sender 50, the title of the E-mail may be distinguished by identifying words “TV program list,” the identification message may include the username, the password, and the encrypted key, and the video request may include the video recording channel, the program class, the recording type, the start time, the end time, the program description information, and the recording extending information.

The mail analyzing module 102 analyzes the title and the identification message of the E-mail to determine whether the title and the identification message comply with predefined requirements.

In one exemplary embodiment, the sender of the E-mail may be the information device 40. In this case, the identifying words are “reserved video recording,” and the identification message only includes the username and the password. In this case, the mail analyzing module 102 determines that the title complies the predefined requirements if the title of the E-mail includes the identifying words “reserved video recording,” otherwise, determines that the title does not comply with the predefined requirements. The mail analyzing module 102 determines that the identification message complies with the predefined requirements if both of the username and the password of the identification message are correct, otherwise, determines that the identification message does not comply with the predefined requirements.

In another exemplary embodiment, the sender of the E-mail may be the TV program mail sender 50. In this case, the identifying words are “TV program list,” and the identification message includes the username, the password, and the encrypted key. In this case, the mail analyzing module 102 determines that the title complies with the predefined requirements if the title of the E-mail includes the identifying words “TV program list,” otherwise, determines that the title does not comply with the predefined requirements. The mail analyzing module 102 determines that the identification message complies with the predefined requirements if the username, the password, and the encrypted key of the identification message are all correct, otherwise, determines that the identification message does not comply with the predefined requirements.

In this exemplary embodiment, the mail transceiving module 100 further determines whether all E-mails have been retrieved when the title or the identification message is incorrect, and retrieves the next E-mail when there are E-mails that have not yet been retrieved.

The scheduling module 104 automatically schedules the video request when both the title and the identification message comply with the predefined requirements.

The mail transceiving module 100 further transmits an acknowledgement E-mail to the sender of the E-mail including the information device 40 or the TV program mail sender 50 to acknowledge that the video request has been successfully scheduled after the scheduling module 104 schedules the video request.

Afterwards, the video recording device 10 automatically records the video data according to the video request.

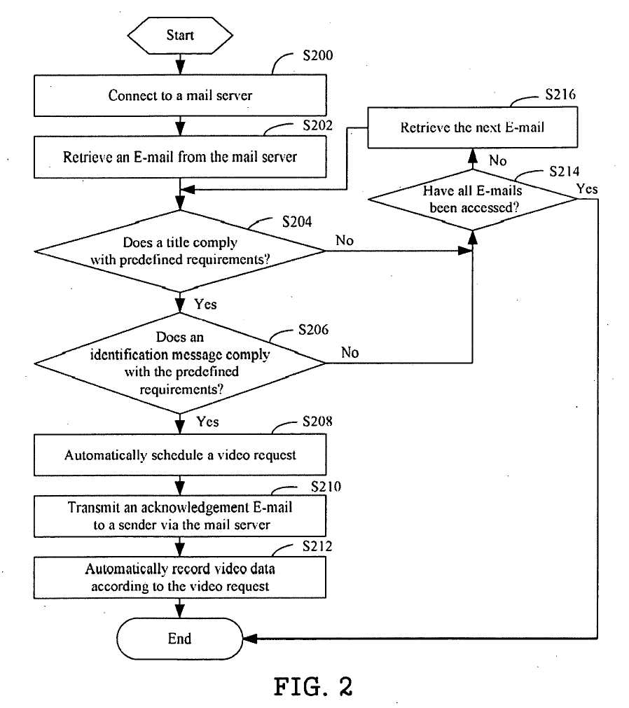

FIG. 2 is a flowchart of a reserved video recording method according to an exemplary embodiment of the present invention.

In step S200, the mail transceiving module 100 connects to the mail server 30. In the exemplary embodiment, the mail transceiving module 100 connects the mail server 30 when notified by the timer 106.

It should be noted that the mail transceiving module 100 may not necessarily need to be notified by the timer 106 in order to retrieve mail. The mail transceiving module 100 also connects to the mail server 30 when it receives a new mail notice sent by the mail server 30.

In step S202, the transceiving module 100 retrieves an E-mail from the mail server 30. In the exemplary embodiment, the E-mail includes a title, an identification message, and a video request.

In one exemplary embodiment, the sender of the E-mail may be the information device 40. In this case, the title of the E-mail is distinguished by the identifying words “reserved video recording,” the identification message only includes the username and the password, and the video request only includes the video recording channel, the start time, and the end time.

In another exemplary embodiment, the sender of the E-mail may be the TV program mail sender 50. In this case, the title of the E-mail may be distinguished by the identifying words “TV program list,” the identification message may include the username, the password, and the encrypted key, and the video request may include the video recording channel, the program class, the recording type, the start time, the end time, the program description information, and the recording extending information.

In step S204, the mail analyzing module 102 analyzes the title of the E-mail to determine whether the title complies with predefined requirements.

In one exemplary embodiment, the sender of the E-mail may be the information device 40, wherein the identifying words may be “reserved video recording.” In this case, the mail analyzing module 102 determines that the title complies with the predefined requirements if the title of the E-mail includes the identifying words “reserved video recording,” otherwise, determines that the title does not comply with the predefined requirements.

In another exemplary embodiment, the sender of the E-mail may be the TV program mail sender 50, wherein the identifying words may be “TV program list.” In this case, the mail analyzing module 102 determines that the title complies with the predefined requirements if the title of the E-mail includes the identifying words “TV program list,” otherwise, determines that the title does not comply with the predefined requirements.

If the title of the E-mail complies with the predefined requirements, in step S206, the mail analyzing module 102 analyzes the identification message of the E-mail to determine whether the identification message complies with the predefined requirements.

In one exemplary embodiment, the sender of the E-mail may be the information device 40, wherein the identification message may include only a username and a password. In this case, the mail analyzing module 102 determines that the identification message complies with the predefined requirements if both the username and the password of the identification message are correct, otherwise, determines that the identification message does not comply with the predefined requirements.

In another exemplary embodiment, the sender of the E-mail may be the TV program mail sender 50, wherein the identification message of the E-mail may include the username, the password, and the encrypted key. In this case, the mail analyzing module 102 determines that the identification message complies with the predefined requirements if the username, the password, and the encrypted key of the E-mail are all correct, otherwise, determines that the identification message does not comply with the predefined requirements.

If the identification message of the E-mail complies with the predefined requirements, in step S208, the scheduling module 104 automatically schedules the video request.

In step S210, the mail transceiving module 100 transmits an acknowledgement E-mail to the sender of the E-mail via the mail server 30 to acknowledge that the video request has been successfully scheduled.

In one exemplary embodiment, the mail transceiving module 100 may transmit the acknowledgement E-mail to the information device 40.

In another exemplary embodiment, the mail transceiving module 100 may transmit the acknowledgement E-mail to the TV program mail sender 50.

In step S212, the video recording device 10 automatically records video data according to the video request.

If the title or the identification message does not comply with the predefined requirements, in step S214, the mail transceiving module 100 determines whether all E-mails have been retrieved.

If one E-mail has not been retrieved, in step S216, the mail transceiving module 100 retrieves next E-mail. The above steps will be repeated until all E-mails have been retrieved.

Therefore, the user can record video data conveniently by sending the E-mail with the video request to the video recording device 10 without having to be near the video recording device 10. The video recording device 10 then automatically schedules the video data to be recorded according to the video request in the E-mail, and thereby automatically records the video data according to the video request.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A video recording device adapted for recording video data according to an E-mail, comprising:
a mail transceiving module, for retrieving the E-mail including a title, an identification message, and a video request;
a mail analyzing module, for analyzing the title and the identification message to determine whether the title and the identification message comply with predefined requirements; and
a scheduling module, for automatically scheduling the video request when both of the title and the identification message comply with the predefined requirements.

2. The video recording device as claimed in claim 1, further comprising a timer, for reminding the mail transceiving module to retrieve the E-mail periodically.

3. The video recording device as claimed in claim 1, wherein the mail transceiving module retrieves the E-mail when a new mail notice is received.

4. The video recording device as claimed in claim 1, wherein the mail transceiving module further transmits an acknowledgement E-mail to a sender of the E-mail to acknowledge that the video request has been successfully scheduled.

5. The video recording device as claimed in claim 1, wherein the mail analyzing module determines that the title complies with the predefined requirements when the title comprises identifying key words, otherwise, determines that the title does not comply with the predefined requirements.

6. The video recording device as claimed in claim 5, wherein the identification message comprises a username and a password for identifying whether the E-mail comprises the video request.

7. The video recording device as claimed in claim 6, wherein the mail analyzing module further determines that the identification message complies with the predefined requirements when both the username and the password of the identification message are correct, otherwise, determines that the identification message does not comply with the predefined requirements.

8. The video recording device as claimed in claim 6, wherein the identification message further comprises an encrypted key.

9. The video recording device as claimed in claim 8, wherein the mail analyzing module further determines the identification message complies with the predefined requirements when the username, the password, and the encrypted key of the identification message are all correct, otherwise, determines that the identification message does not comply with the predefined requirements.

10. A reserved video recording method applied in a video recording device, comprising the steps of:
retrieving an E-mail including a title, an identification message, and a video request;
analyzing the title to determine whether the title complies with predefined requirements;
analyzing the identification message to determine whether the identification message complies with the predefined requirements if the title complies with the predefined requirements; and
automatically scheduling the video request if the identification message complies with the predefined requirements.

11. The reserved video recording method as claimed in claim 10, further comprising the steps of:
providing a timer, for reminding the video recording device to retrieve the E-mail periodically;
connecting to a mail server according to the reminding of the timer; and retrieving the E-mail from the mail server.

12. The reserved video recording method as claimed in claim 10, further comprising the steps of:
connecting to a mail server when a new mail notice is sent by the mail server; and
retrieving the E-mail from the mail server.

13. The reserved video recording method as claimed in claim 10, further comprising the steps of:
transmitting an acknowledgement E-mail to a sender of the E-mail to acknowledge that the video request has been successfully scheduled; and
automatically recording video data according to the video request.

14. The reserved video recording method as claimed in claim 10, further comprising the steps of:
determining whether all E-mails have been retrieved if the title or the identification message do not comply with the predefined requirements; and
retrieving next E-mail if one E-mail has not been retrieved.

15. The reserved video recording method as claimed in claim 10, wherein the step of analyzing the title to determine whether the title complies with predefined requirements comprises the steps of:
determining that the title complies with the predefined requirements if the title comprises identifying key words; and
determining that the title does not comply with the predefined requirements if the title does not comprise the identifying key words.

16. The reserved video recording method as claimed in claim 10, wherein the identification message comprises a username and a password, for identifying whether the E-mail includes the video request.

17. The reserved video recording method as claimed in claim 16, wherein the step of analyzing the identification message to determine whether the identification message complies with the predefined requirements comprises the steps of:
determining that the identification message complies with the predefined requirements when both the username and the password of the identification message are correct; and
determining that the identification message does not comply with the predefined requirements when either the username or password of the identification message is incorrect.

18. The reserved video recording method as claimed in claim 16, wherein the identification message further comprises an encrypted key.

19. The reserved video recording method as claimed in claim 18, wherein the step of analyzing the identification message to determine whether the identification message complies with the predefined requirements comprises the steps of:
determining that the identification message complies with the predefined requirements if the username, the password, and the encrypted key of the identification message are all correct; and
determining that the identification message does not comply with the predefined requirements if either the username, the password, or the encrypted key of the identification message are incorrect.

20. A method to reserve and schedule video recording in a video recording device, comprising:
sending an E-mail to a video recording device by an user of said video recording device;
actively and periodically, by said video recording device, retrieving E-mails including said E-mail sent by said user;
analyzing said E-mail sent by said user; and
automatically scheduling a video recording request when said E-mail contains messages complying with predefined requirements preset in said video recording device.
